(19) United States
(12) Patent Application Publication
(10) Pub. No.: US 2025/0206406 A1
(43) Pub. Date: Jun. 26, 2025

(54) HANDLEBAR WITH CARBON FIBER INSERT

(71) Applicants: Arteom Bulgadarian, Sherman Oaks, CA (US); Patrick Mills, Granada Hills, CA (US)

(72) Inventors: Arteom Bulgadarian, Sherman Oaks, CA (US); Patrick Mills, Granada Hills, CA (US)

(21) Appl. No.: 18/887,963

(22) Filed: Sep. 17, 2024

Related U.S. Application Data
(60) Provisional application No. 63/629,676, filed on Dec. 26, 2023.

(51) Int. Cl. B62K 21/12; C22C 14/00

(52) U.S. Cl. CPC B62K 21/12; C22C 14/00

(57) ABSTRACT

An improved motorcycle handlebar includes a titanium tube having a center section, left and right hand sections, and a motorcycle handlebar bend profile, and a carbon fiber tube internally seated in the center section of the titanium tube—the section that will be clamped into a handlebar mount on a motorcycle. The carbon fiber tube reinforces and strengthens the center section and eliminates the need for a handlebar crossbar. Advantageously, the carbon fiber-reinforced handlebar reduces the vibration felt by a rider when traveling on rough terrain.

### CROSS-REFERENCE TO RELATED APPLICATION

This application claims the benefit of U.S. provisional application No. 63/629,676, filed Dec. 26, 2023, the entire contents of which are incorporated herein by this reference.

### FIELD OF THE INVENTION

The present invention relates to motorcycle components, particularly handlebars.

### BACKGROUND OF THE INVENTION

Many motorcycle enthusiasts favor off-road bikes over street bikes. While street bikes are built for speed, comfort, and/or style and are primarily intended to be ridden on paved roads, off-road bikes (also known as dirt bikes or scramblers) are built for riding on dirt, gravel, sand, mud, and other rough terrain. Dirt bike riders enjoy jumps, sand rollers, whoops, and other challenging obstacles. Several categories of motorcycle riding and motorcycle racing are known, including track, rally, speedway, Supersport, Motocross, Supercross, enduro, and others.

The essential components for all motorcycles are a frame, engine, wheels and tires, suspension, steering, etc., but the specifications for street vs. dirt bikes can be quite different. Motorcycle handlebars allow the rider to steer the bike and maintain control while moving. The forces encountered by the front tire are transmitted through the front fork and shocks to the steering head and handlebars, and to the rider's hands and arms. In general, dirt bikes tend to have greater fork and shock travel than street bikes. A dirt bike rider will typically encounter substantial force and vibrations caused by rough terrain. This can cause the rider to grip the handlebar more tightly in an effort to maintain control. Over gripping can lead to “arm pump,” where blood in the forearms builds up, causing swelling, tingling, discomfort, pain, fatigue, and loss of strength.

In general, motorcycle handlebars are made of tubular stainless steel or chrome-plated steel, or aluminum, bent to a desired profile—width, rise, height, and sweep (also known as “pullback”)—suitable for a given category of bike and/or riding environment (e.g., street, dirt, track, etc.). A variety of components can be mounted to the handlebars, including left and right handgrips, clutch lever, brake lever, throttle control, mirrors, and electronic controls. For dirt bikes, a crossbar is affixed to increase handlebar strength, and this can be covered with a crossbar pad to protect the rider.

Motorcycles handlebars are often secured to the front forks through a “triple clamp.” A bar mount is affixed to the top of the triple clamp, and the center section of the handlebar is secured in place in the bar mount. Optionally, fixed or rotatable risers are secured between the clamp and the handlebars to increase the distance between the steering head and the center section of the handlebars to improve the ergonomics of the motorcycle. Regardless of the particular components employed, all motorcycle handlebars transmit force and vibration to the rider. There is a need for improved handlebars that transmit less vibration yet are strong, lightweight, and durable.

### SUMMARY OF THE INVENTION

The present invention provides an improved motorcycle handlebar having a center section, left and right hand sections, and a motorcycle handlebar bend profile, and a carbon fiber tube seated in the center section of the handlebar—the section that will be clamped into a handlebar mount on a motorcycle. The carbon fiber tube reinforces and strengthens the center section. Advantageously, the carbon fiber-reinforced handlebar reduces the vibration felt by a rider when traveling on rough terrain. In addition, the use of a titanium tube with a carbon fiber insert eliminates the need for a handlebar crossbar.

### BRIEF DESCRIPTION OF THE DRAWINGS

Various features and advantages of the invention will become apparent when considered in conjunction with the appended drawings, which are not necessarily drawn to scale, wherein:

FIG. 1 is a schematic front view of one embodiment of the handlebar of the present invention;

FIG. 2. is a top view of the embodiment shown in FIG. 1;

FIG. 3 is a side view of the embodiment shown in FIG. 1;

FIG. 4. is an end-to-end sectional view of the embodiment shown in FIG. 1;

FIG. 5 is a partial cross-sectional view of the embodiment shown in FIG. 1; and

FIG. 6 is a schematic view of test equipment used for testing one embodiment of a handlebar made according to the invention.

### DETAILED DESCRIPTION

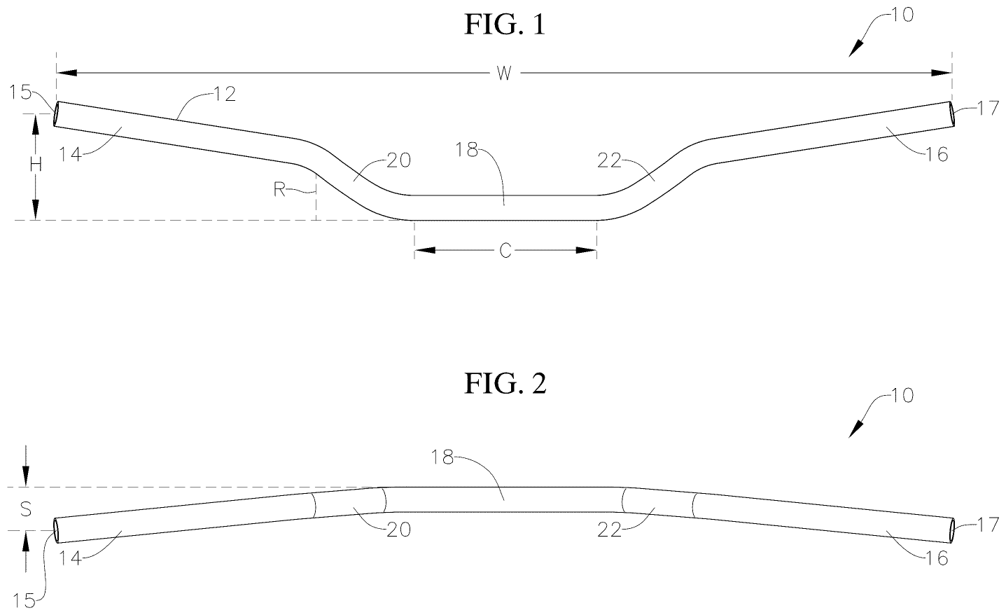

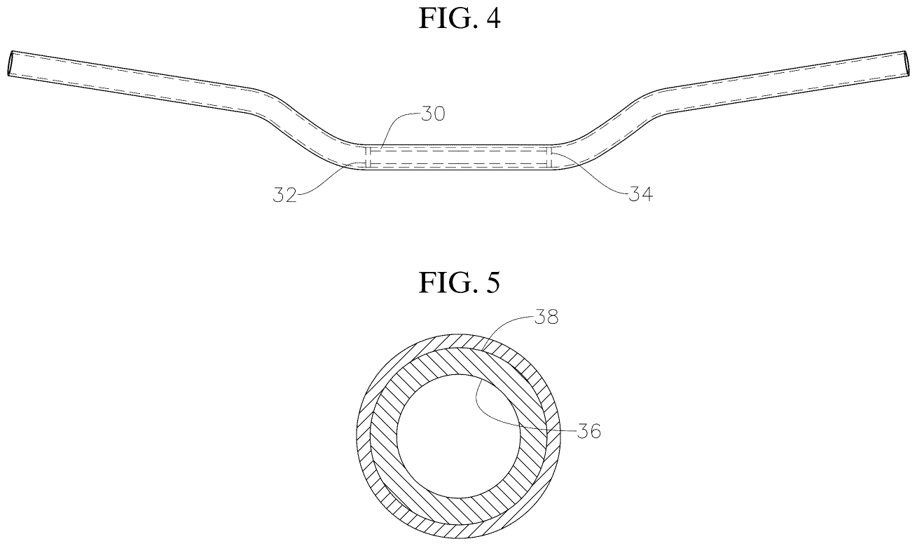

Referring now to FIGS. 1-5, there is shown one embodiment of a motorcycle handlebar that incorporates the features of the present invention. The handlebar 10 includes a titanium metal tube 12 having a motorcycle handlebar bend profile as shown. The titanium tube includes a left hand section 14 and a left end 15, a right hand section 16 and a right end 17, a center section 18 flanked by the left and right hand sections, and left and right transition sections 20, 22 where the center section 18 transitions into the left and right hand sections 14 and 16, respectively. A carbon fiber tube 30 is seated lengthwise and centered within the center section 18 of the titanium metal tube. The carbon fiber tube 30 has a left end 32, right end 34, inner diameter 36 and an outer diameter 38, and is held in place by a friction fit and/or a permanent bonding agent.

Titanium tubing can be purchased commercially, cut to size, and then bent to the desired profile using a tube bending machine. The carbon fiber tube is inserted into the titanium tube prior to bending the titanium tube. As used herein, the term “titanium” is not limited to pure titanium but includes titanium alloyed with small quantities of aluminum, vanadium, and/or other elements. Several grades are available; nonlimiting examples are presented in Table 1.

TABLE 1
Titanium Metal and Selected Alloys

| Grade | Description |
|---|---|
| 1 | “Commercially pure” - At least 99.5% purity; the most ductile and softest grade. |
| 2 | “Commercially pure” - At least 99.2% purity; similar to Grade 1 but with higher |
| | strength and excellent cold forming properties. |
| 5 | Ti—6Al—4V - Contains 6% Al, 4% V, <0.25% Fe, <0.2% O, <0.015% H; balance Ti. |
| | Accounts for 50% of total global titanium usage. It is significantly stronger than |
| | “commercially pure” titanium (grades 1-4) and can be heat treated. |
| 7 | Includes 0.12-0.25% palladium for increased corrosion resistance. Excellent for |
| | marine environments with high chloride exposure. |
| 9 | Ti—3Al—2.5V - Contains 3% Al and 2.5% V. Strong, flexible, weldable, and corrosion |
| | resistant. |

In one embodiment of the invention, the handlebar is made of ⅞″ diameter (0.875 inches OD), seamless, Ti-3 Al-2.5V aerospace grade titanium alloy tubing with a tube wall thickness of 0.061 inches. The ⅞″ diameter handlebars fit into stock handlebar mounts commonly used with motorcycle triple clamps. Alternatively, the handlebars have a diameter of 1″ or 1 and ⅛″ (1.125 inches OD), and larger handlebar mounts are used. The smaller diameter (⅞″) tubing is lighter and less expensive, and for many riders, more ergonomic. Other diameters and dimensions can be used if desired, such as in a custom-built motorcycle.

Carbon fiber tubes are composite materials made by combining strands of carbon fibers with resin and forming a composite material in the form (e.g.) of woven or braided tubes, wrapped carbon tubes, and pultruded tubes. They are commercially available in a variety of weaves, braids, shapes, and other forms. Carbon fibers are extremely strong, stiff, and light, and carbon fiber tubes have excellent strength, stiffness, and modulus. Even a basic, plain-weave carbon fiber panel has a specific stiffness at least twice that of aluminum or steel, and a specific strength five times that of aluminum and more than four times that of steel. A description of carbon fiber composites is found at element6composites.com, incorporated herein by this reference. In one embodiment, the carbon fiber tube has an outer diameter slightly shy of the inner diameter of the titanium tube into which it is inserted. This allows room for a thin layer of bonding agent between the two tubes and makes it easier to insert the carbon fiber tube into the titanium tube.

The carbon fiber tube increases strength in the titanium tube center section—the area that will be clamped to the steering head of the motorcycle. It also helps reduce vibration transmitted from the front suspension and the engine. Inserting a titanium tube into a carbon fiber tube yields a subcombination of the present invention, namely, a titanium tube reinforced by a carbon fiber tube inserted therein. Alternatively, this can be characterized as a carbon fiber tube seated longitudinally within a titanium tube.

A variety of handlebar bend profiles are commonly used in dirt bikes and other motorcycles, and the present invention can be formed to match such profiles. As used herein, the term “motorcycle handlebar bend profile” means that the handlebars have a non-zero height as well as a non-zero “pullback” or “sweep.” In general, both the height and the pullback have positive values. Usually, the height is greater than the rise. In FIGS. 1-5, the handlebar width (W), height (H), rise (R), sweep(S) and center section length (C) are indicated. Nonlimiting examples of motorcycle handlebar bend profiles commonly found on dirt bikes are presented in Table 2. For a few of the profiles, “rise” data has been omitted. Each of the listed profiles has a positive height, rise, and sweep (pullback).

TABLE 2
Common Handlebar Bend Profiles for
Offroad Motorcycles and ATVs

| Name | Width | Height | Rise | Pullback (Sweep) |
|---|---|---|---|---|
| ATV Low Bend | 32.00″ | 5.50″ | 2.64″ | 3.30″ |
| ATV Mid Bend | 32.00″ | 5.90″ | 2.76″ | 3.00″ |
| ATV Hi Bend | 32.00″ | 6.30″ | 2.76″ | 3.94″ |
| CR Low Bend | 31.50″ | 2.80″ | 2.17″ | 2.68″ |
| CR Mid Bend | 31.50″ | 3.23″ | 2.20″ | 2.36″ |
| CR Hi Bend | 31.50″ | 3.74″ | 2.64″ | 2.45″ |
| KTM Bend | 32.00″ | 3.23″ | 1.93″ | 2.36″ |
| KX Low Bend | 31.50″ | 2.80″ | | 2.36″ |
| KX Hi Bend | 32.00″ | 4.25″ | 2.76″ | 3.07″ |
| RM Hi Bend | 31.50″ | 3.23″ | | 2.87″ |
| YZ Low Bend | 31.50″ | 2.64″ | | 2.76″ |
| YZ Hi Bend | 31.50″ | 3.31″ | 2.09″ | 2.95″ |
| Universal Low | 32.00″ | 2.88″ | 1.50″ | 2.24″ |
| Bend | | | | |
| Universal Mid | 32.00″ | 3.39″ | | 2.76″ |
| Bend | | | | |
| Universal Hi | 32.00″ | 3.66″ | | 2.17″ |
| Bend | | | | |

Other dirt bike profiles can be used in the alternative, with modest variations in width, height, rise, and/or sweep while maintaining the “dirt bike” or “tracker bar” look and functionality. The invention also can be used with street bike handlebar profiles, and even more extreme profiles such as seen on “choppers” and other street bikes. Nonlimiting examples include handlebars referred to as “gorilla bars” or “apes,” mini apes, rabbit ears, z-bars, low-z, Frisco, keystone, and a variety of others. In each case, the handlebars have a straight center section in which is seated a carbon fiber tube which reinforces and strengthens the center section. In some “chopper” style bend profiles, the rise is greater than the height; that is, the ends of the handlebars drop below the rise.

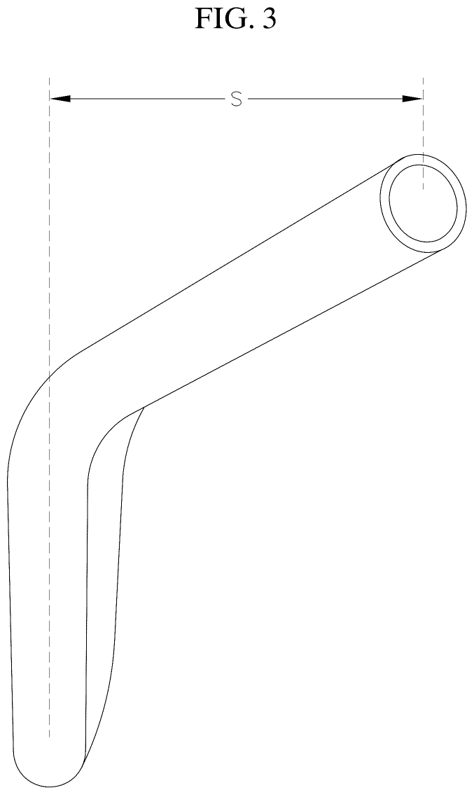

To test the invention, several carbon fiber-reinforced titanium handlebars were manufactured and mounted on off-road motorcycles, which were then driven on different off-road tracks to evaluate handlebar performance. The handlebars were manufactured using the following protocol: 1. Titanium tubing is sourced or cut to a desired “pre-bent” length. 2. The tubing is placed in tooling for precise alignment and spot annealing. Prior to annealing, the sections of the tube that are to remain straight—including left hand section 14, right hand section 16, and center section 18—are covered with thermal insulation. 3. A bonding agent is applied to the outer surface of a carbon fiber tube. 4. The carbon fiber tube is inserted into the titanium tube. 5. The sections to be bent (corresponding to areas 20 and 22 in FIGS. 2 and 3) are heat treated (annealed) to facilitate subsequent bending. 6. The thermal insulation is removed. 7. The titanium tube is bent to a desired bend profile in a temperature-controlled tube bending machine. 8. The outer surface of the handlebar is shot peened using MIL-Spec. shot peening. 9. The handlebar is wiped down and inspected.

Annealing the titanium tube before effecting the bend softens the metal and eases the bending process. In one embodiment, the titanium tube is annealed at a temperature of 1100-1400 degrees F. and then cooled in ambient air. Temperature can be monitored using a calibrated temperature sensing device.

Shot peening converts residual tensile stress into beneficial residual compressive stress at or under the surface of the titanium tube. This improves the metal's strength under load and can increase surface hardness, reduce metal fatigue, and improve handlebar reliability. In one embodiment, the handlebars are racked vertically in a shot peening chamber and shot peened over the entire outer surface of the handlebars using 70 shot, Hardness Rockwell C scale (HRC) 52-65, 0.006″-0.010″ A intensity.

Nonlimiting examples of bonding agents include permanent adhesives such as “Gorilla® Clear Grip Contact Adhesive,” Loctite® permanent adhesives, and the like.

The specifications for a handlebar (Example 1) prepared by this protocol are provided in Table 3.

TABLE 3
Handlebar Example 1

| | Grade | Pre-Bent Length | OD | Wall Thickness |
|---|---|---|---|---|
| Ti Tube | Ti—3Al—2.5V | 33.5″ | 0.875″ | ≥0.061″ |

| | Type | Length | OD | ID |
|---|---|---|---|---|
| C Fiber Tube | Pultruded | 6.00 ± 0.030″ | 0.739 + | 0.530 ± 0.030″ |
| | | | 0.000-0.002″ | |

| | | Center Section | | |
|---|---|---|---|---|
| | Width | Width | Weight | Bend Profile |
| Handlebar | 31.50″ | 7.95″ | 15.5 oz | CR Mid Bend |

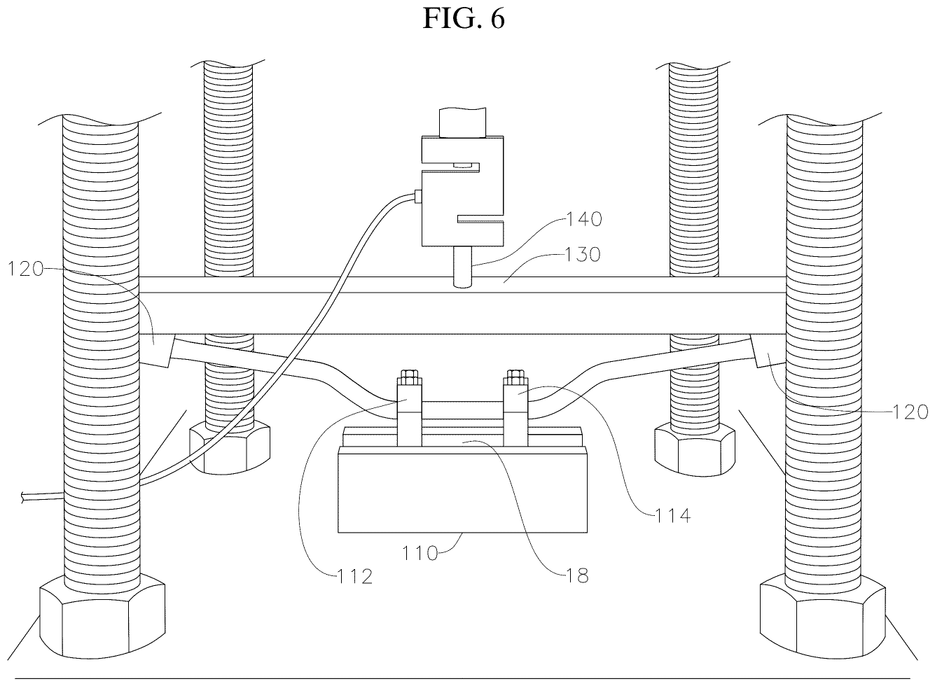

A handlebar prepared as in Example 1 was subjected to cyclic load testing in test equipment as shown in FIG. 6. In each test, the center section 18 of the handlebar 10 was clamped to a fixed mount 110. Large metal cylinders 120 were affixed to the left and right hand sections of the handlebar to increase their surface area and thereby facilitate better mating with a horizontally aligned, large rectangular bar 130 of metal spanning the width of the handlebar. A motor-driven ram 140 was affixed to the rectangular bar.

In Test No. 1, when the ram was actuated, the handlebar was subjected to a downwardly directed force of 300 lbf at a cycle rate of 20 cycles per minute for 15,000 cycles. This force caused a mechanical stress where the handlebar center section 18 was clamped in the mount, particularly at both the left and right clamp locations 112, 114. This test was designed to replicate actual conditions seen on a motocross track, where a heavy load (300 lbf) is encountered due to large jumps and whoops. In Test No. 2, 150 lbf was applied at a cycle rate of 60 cycles per minute for 20,000 cycles. This lighter load but higher cycle rate was designed to replicate sustained vibration caused by riding on rough terrain.

Visual and x-ray analysis of the handlebar subjected to Test No. 1 revealed no discernible signs of cracking or damage. Similarly, after the same handlebar was subjected to Test No. 2, visual and x-ray analysis revealed no discernible signs of cracking or damage.

After two successful tests with no observable damage, it was decided to subject the handlebar to a destructive test to determine the physical limits of the handlebar. In Test No. 3, the handlebar was loaded slowly with ever increasing force to determine the point at which damage or cracking was observed. However, even when the handlebar was loaded with 1,915 lb of downwardly directed force, and the bar was fully deflected to the horizontal bed of the test table, there was still no visible evidence of cracking and only a small amount of deformation noted.

The results of Test Nos. 1-2 demonstrate that a handlebar prepared in accordance with the present invention will be able to perform even under actual racing conditions-despite the absence of a crossbar. The result of Test No. 3 demonstrates that the handlebar has a high safety factor and will hold up well in the event of a crash-despite the absence of a crossbar.

Off-road testing of carbon fiber-reinforced titanium handlebars prepared in accordance with the present invention also demonstrates a high level of performance and rider satisfaction. The handlebars were mounted on motocross motorcycles. Over several days, on two different types of motocross (MX) tracks, test riders put the handlebars through their paces. One track was mostly “hard pack,” with a very hard base yet plenty of rough sections where the track has started to break down from other riders. A second track was softer, with a layer of sand overlying a hard base. It was designed to accommodate high speed, larger outdoor MX jumps, and sand whoops. Both tracks are constantly in use for both racing and practice sessions throughout the year.

The new handlebars performed exceedingly well in off-road testing, with a noticeable improvement in performance and characteristics as compared to prior art MX handlebars. One of the observed performance benefits was a smoother ride sensation, with the handlebars soaking up some of the more aggressive bumps and chatter typically felt on the tracks. The handlebars also absorbed a lot of the motorcycle engine vibration, as compared to that felt with aluminum handlebars, which are stiff and prone to heavy vibrations. This translated into less arm and hand fatigue felt by the rider, and more control, allowing the test rider to “ride longer and push harder.”

The invention offers an advantage over a handlebar made entirely of titanium, as the center section is reinforced with a strong carbon fiber insert. This helps absorb energy and reinforces the clamping area, which otherwise could suffer mechanical deformation in the event of over-torquing of the bar mounting bolts. The invention is also superior to a handlebar made entirely of carbon fiber, which is more prone to break in the event of a crash or hard impact.

The invention is not limited to the particular examples and embodiments described herein. For example, the handlebars can be mounted on other types of vehicles, e.g., all-terrain vehicles (ATVs), snowmobiles, on-road motorcycles (street bikes), e-bikes, and even ordinary bicycles. In an alternate embodiment, instead of titanium, the carbon fiber-reinforced handlebars of the present invention can be made of aluminum, steel, or a different metal. The invention is limited only by the appended claims and equivalents thereof. Unless otherwise stated or implied by context, the terms “handlebar” and “handlebars” are used interchangeably.

What is claimed is:

1. A motorcycle handlebar, comprising:
a titanium tube having a motorcycle handlebar bend profile; and
a carbon fiber tube seated longitudinally within the titanium tube.

2. The motorcycle handlebar of claim 1, wherein the titanium tube is made of Ti-3Al-2.5V alloy.

3. The motorcycle handlebar of claim 1, wherein the carbon fiber tube is permanently bonded to the titanium tube.

4. The motorcycle handlebar of claim 1, wherein the titanium tube includes a center section flanked by left and right hand sections and the carbon fiber tube is seated within the center section of the titanium tube.

5. The motorcycle handlebar of claim 1 wherein the motorcycle handlebar bend profile is a CR mid bend profile.

6. The motorcycle handlebar of claim 1, having a shot peened outer surface.

7. A motorcycle handlebar, comprising:
a metal tube having a center section and a motorcycle handlebar bend profile; and
a carbon fiber tube seated longitudinally within the center section of the metal tube.

8. The motorcycle handlebar of claim 7, wherein the titanium tube is made of Ti-3Al-2.5V alloy.

9. A titanium tube reinforced by a carbon fiber tube inserted therein.

10. A carbon fiber tube seated longitudinally within a titanium tube.
